(19) United States
(12) Patent Application Publication
(10) Pub. No.: US 2008/0163729 A1
(43) Pub. Date: Jul. 10, 2008

(54) Locking pliers with longitudinal jaw teeth, impactable jaws and jacking bolts

(76) Inventor: Mark Anthony Stevens, Lexington, OH (US)

Correspondence Address: Mark Stevens, 184 Industrial Drive, Lexington, OH, 44904, US

(21) Appl. No.: 12/004,790

(22) Filed: Dec. 21, 2007

Related U.S. Application Data
(60) Provisional application No. 60/879,451, filed on Jan. 9, 2007.

(51) Int. Cl. B25B 7/14; B25B 7/00; B25B 7/02

(52) U.S. Cl. 81/319; 81/318; 81/418

(57) ABSTRACT

A hand tools similar in design to the commonly known locking pliers which are available in a number of configurations. The present invention includes enhancements that allow the tool to efficiently and effectively provide force parallel to the centerline of a controlled article, i.e. a shaft. Inclusion of reinforced jaws, a plurality of parallel oriented jaw ridges (teeth) and holes for the employment of jack bolts allow this tool the option of providing much of the same utility as the common variety of locking pliers while allowing the above mentioned longitudinal force application. This force application is enhanced by the use of impact tools on the reinforced jaw and/or jack bolts.

This application claims the priority of U.S. Provisional Patent No. 60/897,451 filed on Jan. 25, 2007.

### BACKGROUND OF THE INVENTION

1. Technical Field

The invention relates to an improved hand tool to be used to grasp material that requires additional manipulation. More particularly, the invention relates to such a tool having the basic design of locking pliers comprised of enhancements for delivering longitudinal force. Specifically, the invention relates to locking pliers with the addition of a plurality of longitudinal jaw teeth, reinforced impact receptive jaws and the inclusion of holes for the employment of jacking bolts.

2. Background Information

Locking pliers are well known in the art. These devices typically include two jaws that may be locked about an object. The locking is effected by forcing two handles together wherein the handles cooperate to form an over center mechanism.

The art is rife with many configurations of the well known locking pliers designed to hold a variety of items and employed across a number of markets segments. A plethora of styles and sizes is available and they all provide for control of material and in many case, when not simply a clamping device, for the application of force in a torsional orientation. These types of tools are well suited for these applications and are easy to use and understand. The innovations in such pliers are marked largely by improvements to the toggle mechanisms that permit the jaws to not only accommodate differently sized objects but also to lock onto the objects with varying degrees of force.

In many applications there is a requirement to not only control an item but to apply longitudinal force, that is to say force in the direction of the centerline of the article. The present invention through the employment of modified jaw teeth, reinforced jaws and other new characteristics provides the opportunity to more efficiently exert this type of force. Although the standard configuration of locking pliers can be used in the manner they possess several design deficiencies that are overcome by the present invention.

In Janson U.S. Pat. No. 7,044,032 and Wang U.S. Pat. No. 6,857,342 the articles are locking pliers of the normally accepted configuration. Although they are very capable of performing their primary function of securely grasping objects in their jaws, their design does not provide for effective or efficient application of longitudinal force to the grasped article. The cited inventions have a plurality of teeth oriented perpendicular to the length of their jaws and have the intended use of manipulating the grasped material in a torsional manner. Additionally, the configuration is not designed to withstand application of impactful force from the use of supplemental tools such as hammers.

Further, in Helms U.S. Pat. No. 3,793,914, we see pliers that do not have the locking mechanism but that are very capable of grasping items. These are also very common in the art. This configuration is also not designed with the intent of being used to effectively apply longitudinal force as is required in activities such as pulling a shaft from a bearing.

### BRIEF SUMMARY OF THE INVENTION

The present invention provides a hand tool similar to standard locking pliers comprising a connected set of jaw/handle assemblies constructed of a rigid material. The top jaw is rigidly attached to the top handle whereas the bottom jaw is connected to both the top jaw and the bottom handle through pivot connections. The bottom jaw is articulated though the movement of the bottom handle; opening the bottom handle (moving it away from the top handle) moves the bottom jaw away from the top jaw and the converse is true. The invention also employs an adjustable locking mechanism with release that allows the tool to be locked into the closed position. Both jaws include a plurality of teeth that are oriented parallel to the length of the invention.

The present invention can be used to grasp an item in the jaws with the tool being locked closed. The controlled material can then be manipulated with the invention. The design enhancements of the present invention allow for the effective application of force in a direction that is perpendicular to the length of the pliers. Inclusion of robust reinforcements on the jaw end of the tool provides contact points allowing for the use of additional tools, such as hammers, in conjunction with the invention. Inclusion of bolt holes in the reinforcements provide for the employment of jack bolts. Jack bolts will increase the utility of the tool by offering a secondary method for application of force. This tandem use of tools will allow for increased force to be applied to the materials being held be the invention. Common examples would be the removal of shafts from bearings or nails from any number of materials.

### BRIEF DESCRIPTION OF THE SEVERAL VIEWS OF THE DRAWINGS

Preferred embodiments of the invention, illustrative of the best modes in which the applicant contemplates applying the principles, are set forth in the following description and are shown in the drawings and are particularly and distinctly pointed out and are set forth in the appended claims.

FIG. 1 is a side view of the invention, jaws and handles in the closed position,

FIG. 2 is a perspective view of the front end of the invention focusing on the reinforced jaws and the orientation of the teeth

FIG. 3 front end view of invention with jack bolts fully through the reinforced jaws applying force to the insertion plane of the material that is grasped by the invention

FIG. 4 is a perspective view detailing the use of the invention, engaging a shaft like item

FIG. 5 is a perspective view detailing the use of the invention, engaging a shaft like item; note the force application being provided by a hammer like tool

Similar numerals refer to similar parts throughout the specification.

### DETAILED DESCRIPTION OF THE INVENTION

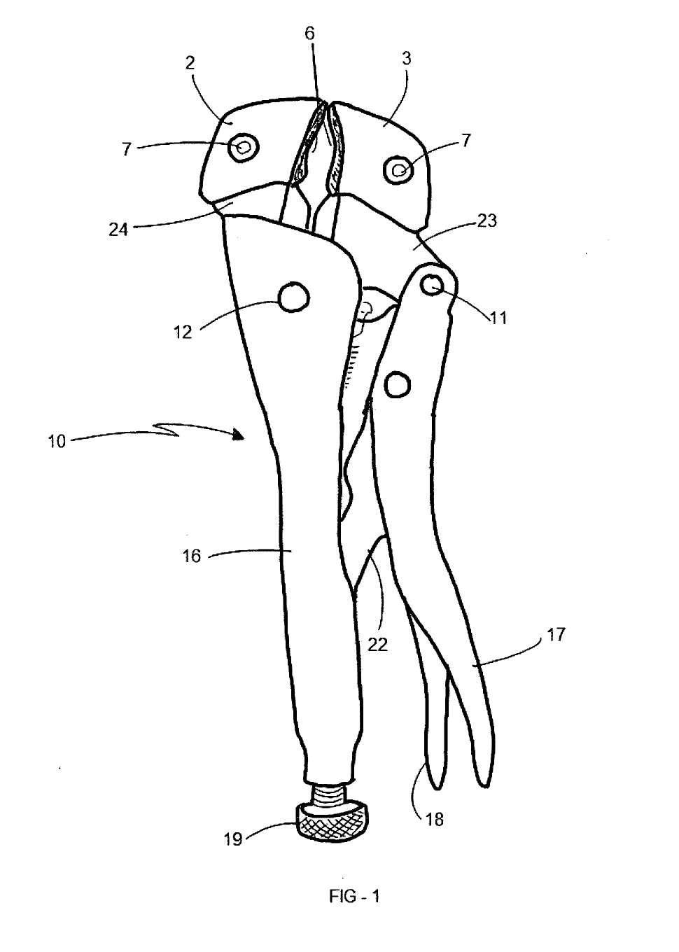

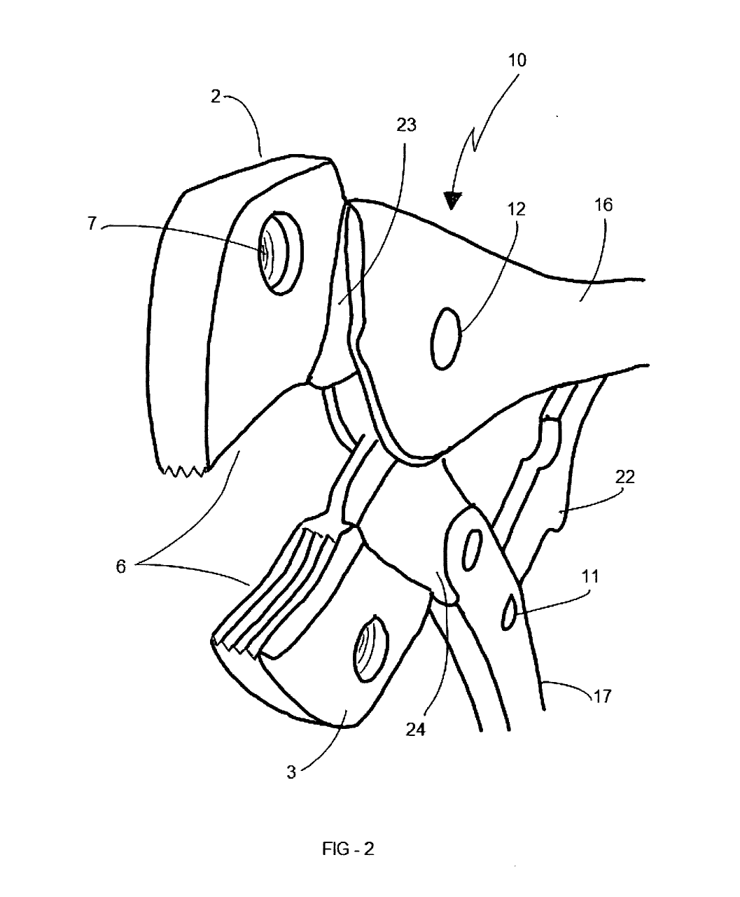

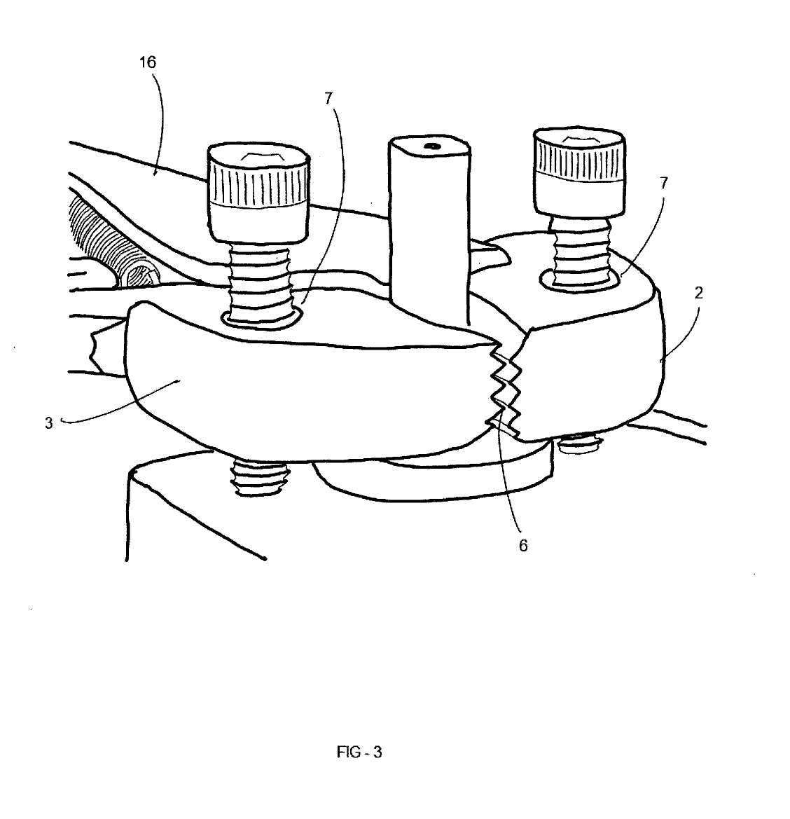

The hand tool of the present invention is indicated generally in 10 in FIG. 1. A front end view of the tools is presented in FIG. 2, giving emphasis to the plurality of jaw ridges, orientation of the jaw ridges and the invention when in the open state. By manipulating the handles 16 and 17, FIG. 1, the jaws 23 and 24, FIGS. 1 and 2 are opened. Said tool can be used for a variety of holding/grasping operations but by its design is particularly suited to manipulate items requiring force application along the centerline of the material; e.g. pulling a shaft, etc. FIGS. 3, 4, and 5. This suitability is driven by features to be detailed in the following paragraphs; reinforced jaws 2 and 3 in all figures, jack bolts holes 7 notably in FIGS. 2 and 7, and the orientation of the jaw ridges 6, FIGS. 1 and 2.

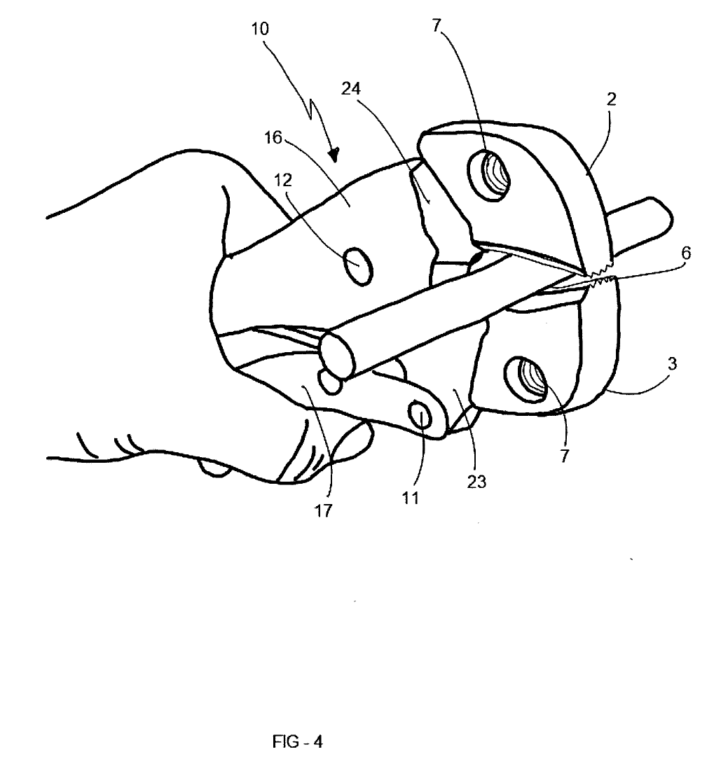

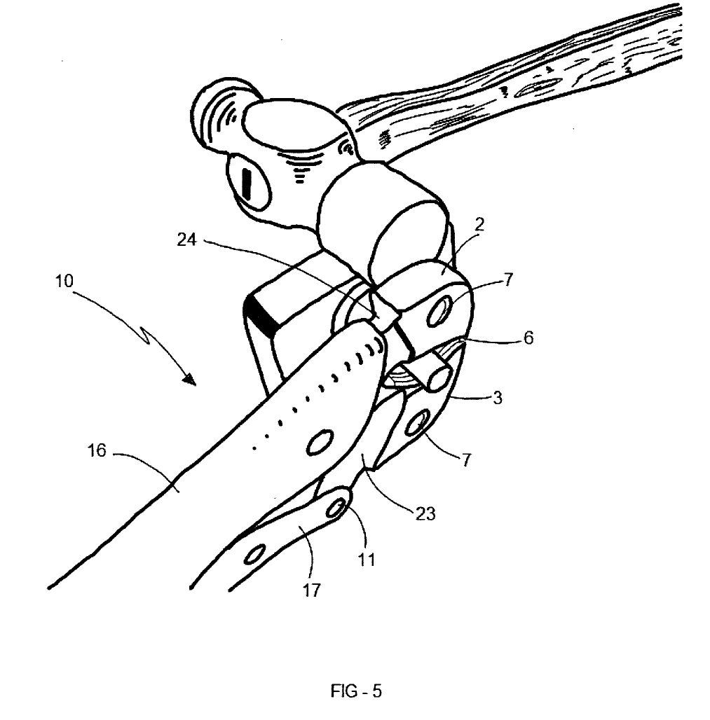

The invention is comprised of two handles (16, 17) and two jaws (23, 24) seen in FIGS. 1 and 2. These are connected via pivots 11 and 12, FIG. 1 and are manipulated using a scissor-like motion. Lower handle 17 is also comprised of a lock release handle 18, FIG. 1 which is connected to 17 with a pivot and this pivot is shared with locking mechanism 22, FIG. 1. The locking mechanism, 22, of the invention is connected via pivot to lower handle 17 and is in controlled contact with upper handle 16 and locking adjustment screw 19, FIG. 1. When the invention 10 is in the closed and locked position, the tool can be opened by employing lock release 18, by moving it towards lower handle 17. By changing the adjusting screw 19 the distance between jaws 23 and 24, when the tool is closed, is altered, thereby affecting the size of the material to be grasped by the tool, FIG. 4. Jaws 23 and 24 are both comprised of a plurality of ridges 6, FIG. 2 that are oriented parallel to the length of the tool 10, reinforced contact areas (2, 3) and bolt holes 7, FIG. 2 that are countersunk, threaded through holes in the reinforced contact areas (2,3). Bolts can be threaded into 7 to apply force to a flat surface FIG. 3 as an assist to tool 10 applying force longitudinal to the material being grasped by the invention. The reinforced contact areas (2,3) FIG. 5 are designed to received and translate energy provided to the tool via the use of impact tools like hammers. This force also increase the force application of the tool along the center line of items being held by the invention. Standard locking pliers are not designed to hold up to repeated impact abuse by supplemental tools. The plurality of jaw ridges, teeth, 6, FIG. 4 which are located on each jaw 23 and 24 assist with the tools ability to grasp items and to maintain this control while force is being applied perpendicular to the length of the invention. The standard embodiment of locking pliers have jaw ridges that run perpendicular to the jaws are be best suited when force is applied in a torsional orientation.

In the foregoing description, certain terms have been used for brevity, clearness, and understanding. No unnecessary limitations are to be implied therefrom beyond the requirement of the prior art because such terms are used for descriptive purposes and are intended to be broadly construed.

Moreover, the description and illustration of the invention is an example and the invention is not limited to the exact details shown or described.

1. A plier like hand tool comprising;
a connected set of handle/jaw assemblies constructed of a rigid material;
top handle and jaw rigidly connected;
bottom jaw affixed to both the bottom handle and the top jaw with pivots;
a plurality of ridged on each jaw oriented parallel to the length of the jaw and parallel to the length of the invention;
an adjustable locking mechanism for securing the jaws in the closed position;
a release handle for disengaging the above mentioned locking mechanism;
reinforcements, suited for receiving impact, on both top and bottom jaws;
countersunk threaded through holes on the jaw reinforcements, one on each jaw.

2. The tool in claim 1 wherein the tool possesses, as a result of the parallel orientation of the jaw ridges, the ability to apply longitudinal force more effectively upon articles grasped in the tool's jaws.

3. The tool in claim 1 wherein the tool possesses, as a result of the reinforced impactable jaws, the capacity to efficiently employ a force that is perpendicular to the length of the pliers through the use of a secondary impact tool and/or the employment of jack bolts through the holes in the inventions jaws.
